(19) United States
(12) Patent Application Publication
(10) Pub. No.: US 2021/0233081 A1
(43) Pub. Date: Jul. 29, 2021

(54) EMBEDDING INFERRED REACTION CORRESPONDENCE FROM DECLINE DATA

(71) Applicant: VISA INTERNATIONAL SERVICE ASSOCIATION, San Francisco, CA (US)

(72) Inventors: Theodore Harris, Foster City, CA (US); Craig O'Connell, London, CA (US); Tatiana Korolevskaya, Foster City, CA (US); Yue Li, Sunnyvale, CA (US)

(21) Appl. No.: 16/773,412

(22) Filed: Jan. 27, 2020

(51) Int. Cl. G06Q 20/40

(52) U.S. Cl. CPC G06Q 20/4016

(57) ABSTRACT

A computer-implemented method of using past transaction declines to predict future fraudulent behavior. A transaction has been declined for an account is determined, and a risk score is determined. The risk score is compared to a risk threshold. The transaction is compared to one or more transactions in a transaction profile for a past fraudster in response to the risk score being determined to be over the risk threshold. A best fit of the transaction profiles of the past fraudster is determined and a measure of success for the best fit of the transaction profiles of the past fraudster is also determined. If the measure of success is over a threshold, the method updates profiles of past fraudsters based on the transaction to include the transaction that has been declined. The method predicts future fraudulent transactions and attempts to stop future fraudulent transactions based on the predicted future fraudulent transactions.

### TECHNICAL FIELD

Embodiments discussed herein generally relate to fraudulent transactions and declined transaction data.

### BACKGROUND

Credit cards have enabling users to make purchases without cash in a variety of settings. This convenience sometimes comes at a cost where criminals have found a way to obtain credit card numbers from the users. For example, criminals have copied credit cards and/or credit card numbers when they were handed to waiters/waitresses at dining establishments. These copied cards or numbers may make their way to black markets, and criminals may purchase goods and services with someone else's numbers. Other ways criminals have obtained someone else's credit cards are through hacking of merchants' computer systems to obtain the numbers.

Users used to spend time to carefully review credit card statements to identify these fraudulent charges and report them to the card issuers so that the charges may be investigated and/or reversed. Since the loss will be borne by the banks or issuers, these institutions have employed various approaches to proactively prevent fraudulent charges to begin in the first place.

However, fraudulent charges is a dynamic problem driven by intelligent agents or criminals who can quick adapt to static fraud models that these institutions employ. Moreover, much of the efforts (e.g., by identity theft prevention institutions) are done in identifying and tracking stolen card numbers in the dark web so as to proactively provide solutions to the users.

Therefore, embodiments attempt to create a technical solution to address the deficiencies of the challenges above by employing a machine learning (ML) or artificial intelligence (AI) system that may anticipate a fraudster's next moves.

### SUMMARY

Embodiments enable a system to initially provide an expected fraud risk data and update the data after a use real-time decline information is issued. In one embodiment, the decline information may further be provided along with weighted matrixes adjusted using the game theory. In one embodiment, the data may include an index table. Moreover, the system may predict next best solution matrix given historical data when faced with declines. Embodiments may further provide these next best solution to update dynamic risk index tables to be ingested by the real-time risk scoring model.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1A is a diagram illustrating a system for a typical purchase transaction by an authenticated user of payment devices according to one embodiment.

FIG. 1B is a diagram illustrating a system for embedding inferred reaction correspondence from decline data according to one embodiment.

FIGS. 2A to 2D are diagrams illustrating denial decision may generate projected next strategy according to one embodiment.

FIG. 3 is a diagram illustrating an overall solution flow according to one embodiment.

FIG. 4 is a diagram illustrating a data structure according to one embodiment.

FIG. 5 is a flow diagram illustrating a computer-implemented method for a delayed according to one embodiment.

FIG. 6 is a diagram illustrating a portable computing device according to one embodiment.

FIG. 7 is a diagram illustrating a computing device according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Aspects of embodiments generate a dynamic solution to prevent fraudulent transactions. Based on historical data of transactions after the transactions have been denied, embodiments build an index table and assign weighted matrixes adjusted using the game theory to predict next best solution matrix as a function of the historical data when faced with declines.

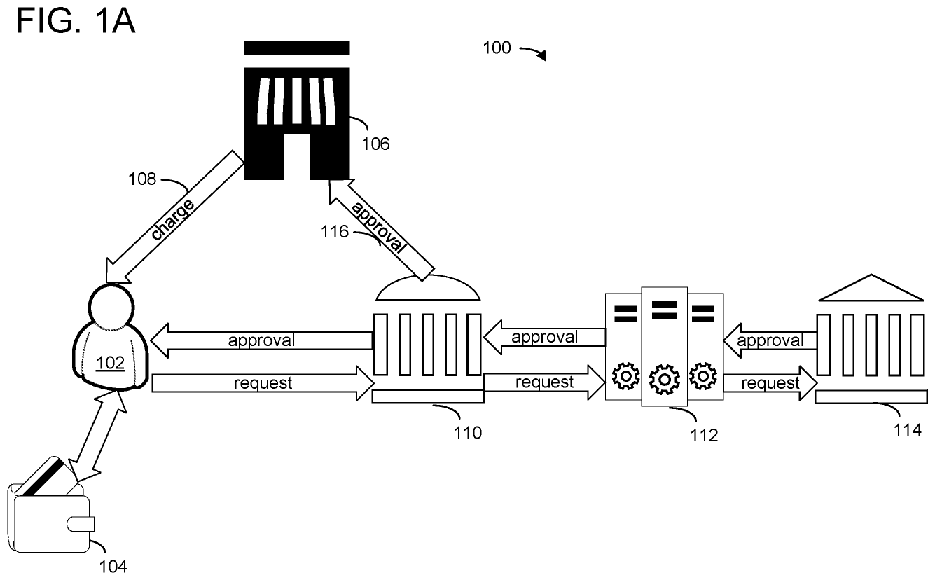

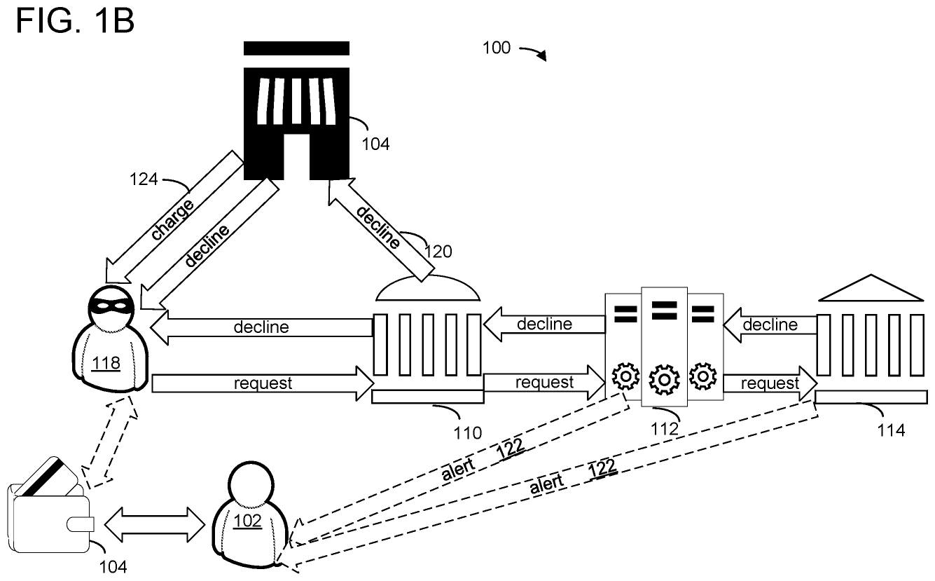

Referring now to FIG. 1A, a system 100 illustrating how a typical authenticated owner of payment devices according to one embodiment. In this example, a user 102 may possess one or more payment devices (e.g., credit cards, debit cards, prepaid cards, etc.) in his wallet or her purse 104 or a digital wallet (hereinafter “wallet”). The user 102 may visit a merchant 106, regardless of being a physical store or an online store, to make a purchase. The merchant 106 may issue a charge 108 to the user 102, and this charge 108 may be treated as a request from one of the payment devices to an acquirer 110, a payment processor 112, and to an issuer 114 of the payment device. Once an authentication process has completed, the issuer 114 may return with an approval 116, and such approval may pass along the merchant 106 through the payment processor 112 and the acquirer 110. With the approval 116, the merchant 106 is paid for the transaction.

However, referring now to FIG. 1B, an identity thief or a hacker (hereinafter “criminal”) 118 may have obtained the user 102's identify and accessed to the wallet 104. As such, the criminal 118 may then use one or more payment devices in the wallet 104 to make a purchase at the merchant 104. The merchant 104 may submit a charge 124 as usual, but the request, by the time it reaches the issuer 114 or the payment processor 112, the issuer 114 or the payment processor 112 may decline 120 the request. The decline message may be routed to the merchant 104 or the criminal 118.

In another embodiment, an alert message 122 from either the payment processor 112 or the issuer 114 may be sent to the user 102 to alert the user 102 of the charge 124 and the decline 120. The user 102 may then confirm that the charge 124 was not authorized. In another embodiment, the alert 122 may be sent shortly after or simultaneously when the decline 120 was issued. In a further embodiment, the decline 120 may be sent after the user 102 reviews a statement of the payment device that includes the charge 124 and has determined that the charge 124 was not authorized.

However the decline 120 is issued, parties such as the payment processor 112 or the issuer 114 may now store such issuance as part of the historical record or historical data. However, it is assumed that the criminal 118 may move on to the next card or card number so a card-focused or number-focused approach would not yield much intelligence.

Aspects of embodiments build on a transaction risk model that reviews not only the account that has suffered a fraudulent charge but also reviews all aspects of the transaction, such as the merchant, time of day (“TOD”), amount of the transaction. In other words, aspects of embodiments attempt to build a model that may be account-neutral or account-agnostic.

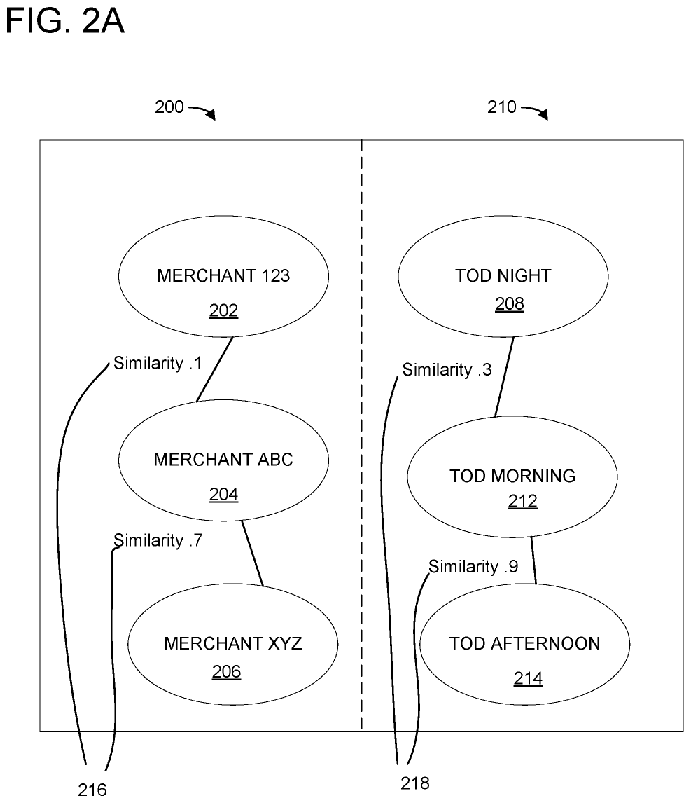

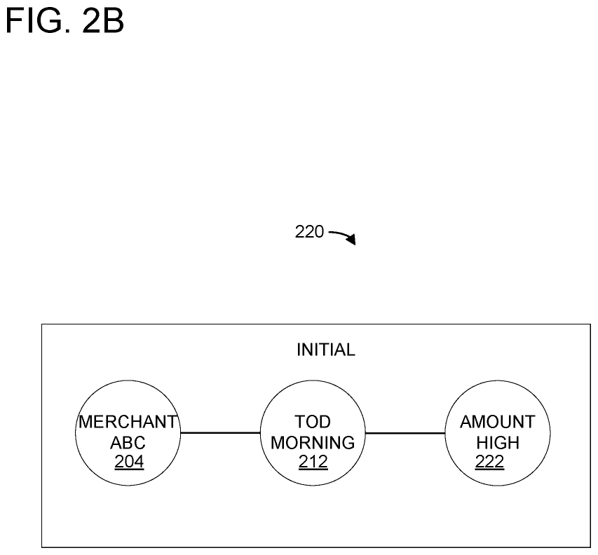

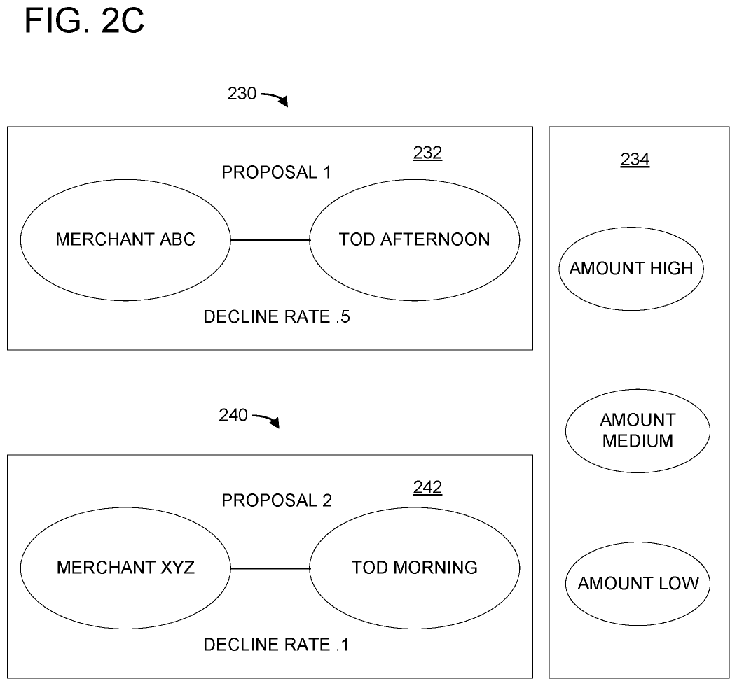

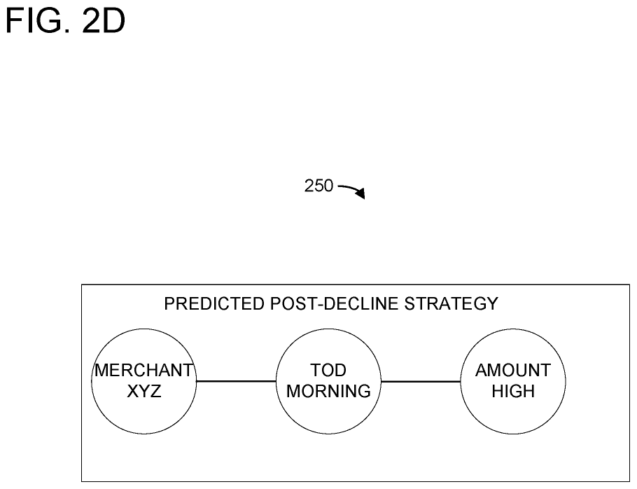

Referring now to FIGS. 2A to 2C, a set of diagrams may illustrate aspects of embodiments in constructing a transaction risk model. For example, FIG. 2A may illustrate graphs 200 and 210 that may represent a fraudster or a criminal's strategy in committing credit card fraud. For example, the criminal 118 may obtain information of a payment device (e.g., credit card) fraudulently. As such, under the graph 200, the criminal 118 may target merchant 123 202, merchant ABC 204, and merchant XYZ 206 as potential stores where the criminal 118 might make a purchase. Separately, as part of the strategy, under the graph 210, the criminal 118 may determine the time of day (“TOD”) to make purchases, as an attempt to make the purchases appear to be normal and not to trigger any fraudulent model. For example, the strategy may separate TOD to night 208, morning 212 and afternoon 214.

It is to be understood that other granular division of the TOD may be used without departing from the spirit and scope of the embodiments.

In another embodiment, the determination of which merchant or at what TOD the criminal 118 may wish to make a purchase may depend on various factors. To determine a similarity factor 216 for the merchants and a similarity factor 218 for TOD, a graph learner algorithm may be used. For example, a similarity score, point, or rating may represent how fraud action change after a current transaction is declined and based on past model performance. In another example, a Dijkstra's shortest path algorithm may be used and the following is an exemplary pseudo code for a modified Dijkstra's shortest path according to one embodiment:

Graph = Global Graph of possible actions
LinkageRules = Definitions of how vertices can be linked (e.g. cannot

link amount twice)

# Initialization
Vertex = Graph.V( )
TargetVerts = set( )
for v_from in Vertex:

from_type = Graph[v_from].type
for v_to each Vertex:

if v_from != v_to
to_type = Graph[v_to].type
# If linkage is allowed
if LinkageRules[from_type][to_type]:

dist[v_to][v_to] = −1
dist[v_from][v_to] = 0
TargetVerts.set(v_from)

def Dijkstra(v_from):

while TargetVerts is not empty:

u = node in TargetVerts with smallest, non-neg, dist[ ]
remove u from TargetVerts
# where v has not yet been removed from TargetVerts
for each neighbor v of u:

```
  alt = dist[u] + dist_between(u, v)
  if alt < dist[v]:
```

dist[u][v] = alt

return dist

In one embodiment, with the Dijkstra's shortest path, a strategy of the criminal 118's actions may be represented as a graph, such as the graphs in FIG. 2A. In addition, based on the similarity rating or score (e.g., “0.1,” “0.7,” for the merchant and “0.3,” and “0.9” for the TOD), proposals may be generated.

In one example, the score may be generated using the distance between nodes calculated using a recursive depth first search. For example, adding to the above equation:

def dist_between(self, start_node, to_node , path = [ ]):

path = path + [start_node]
if to_node in Graph[start_node]:

return path, [1]

for node in Graph[start_node]:

if node == to_node:

res = node
break

if not node in path and node in Graph :

path, res = self.dist_between(node, to_node, path)

return path, res

Referring now to FIG. 2B, a particular fraudster (e.g., criminal 118) may initial employ a strategy as shown in diagram 220. For example, the criminal 118 may employ an initial strategy of committing a fraudulent charge to merchant ABC 204 during the morning of TOD 212 for a high amount 222. This initial strategy may go through, but in the event that the strategy fails, the criminal 118 may receive a denial, such as denial 120. As a result of the denial 120, the criminal 118 may wish to employ a different strategy or a new plan to commit the fraud. Logical thinking would suggest that the criminal 118 may wish to minimize effort and maximize reward, referring now to FIG. 2C, two proposals may be generated based on the similarity score or rating in FIG. 2A. For example, the two proposals may represent two potential approaches that the criminal 118 may proceed to perpetrate the fraud. In one proposal 232 showing in diagram 230, the criminal 118 may proceed to try merchant ABC 204 again, but at a different TOD: in the afternoon. In proposal 242 in diagram 240, the criminal 118 may proceed to try a different merchant, merchant XYZ in the morning, instead of the afternoon.

Based on these two proposals, aspects of embodiments may generate a possible decline rate for each proposal. In this example, the decline rate for the proposal 232 may be 0.5 or 50% while the decline rate for the proposal 242 may be 0.1 or 10%.

In one embodiment, the decline rate may be a weighted probability of decline of the given chain of actions. For example, given the account, the merchant (e.g., location and type), and the TOD, the system 100 may determine the rate of decline as shown in FIG. 2C. Other factors are: seasonality; type of transactions (e.g., card holder present or not present; amount); and location (e.g., IP address or geographical identifier)

In one aspect, amount of the proposals may be shown in column 234, but the different amounts may not have altered the decline rate because the different amounts, however small or large, are still fraudulent amounts.

Once determined, aspects of embodiments may construct or generate a “predicted post-decline strategy” in FIG. 2D illustrating how the criminal 118 may attempt to perpetrate the fraud. As such, instead of waiting as an after-thought for detecting the fraud and then issue the decline, embodiments may anticipate or infer the next approach in fraud detection and process such actions for additional analysis.

For example, based on the prediction in FIG. 2, the criminal 118 may most likely try to charge a high amount at merchant XYZ in the morning.

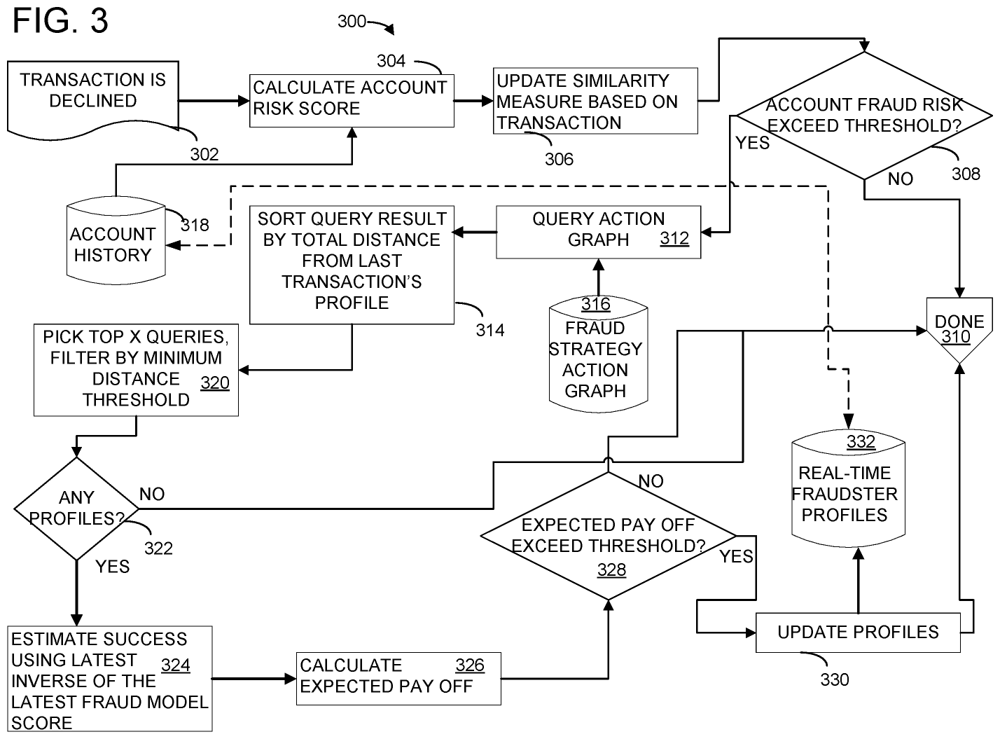

Referring now to FIG. 3, a system diagram 300 illustrates an overall solution flow according to one embodiment. At 302, a transaction is declined. This event may be either detected by the system 100 (e.g., at the payment processor 112 or issuer 114), received at the system 100, or generated by the system 100. Once the transaction is declined or the decline notification is generated, the system 100 may proceed calculate an account risk score at 304. In one embodiment, the system 100 may store a set of account transaction history in a database 318 and the history in the database 318 may be used as part of the calculation. In one embodiment, the system 100 may determine an account associated with a particular payment device. In another embodiment, the system 100 may determine the risk score based on a wallet account, which may include one or more payment devices.

Once the risk score is calculated, the system 100 may at 306 update a similarity measure based on the transaction. For example, the similarity measure (e.g., as shown in FIG. 2C) may be updated in view of the decline of the transaction (e.g., charge 124). The system 100 may next determine at 308 whether the account risk score or fraud risk exceeds a threshold? If the determination is negative, the system 100 may terminate the remaining analysis at 310. On the other hand, if the determination is positive, then the system 100 may proceed to 312 to query action graph (e.g., FIG. 2A) and to sort query result by total distance from last transaction's profiles at 314. In one embodiment, the system 100 may include a database 316 for storing a collection of fraud strategy action graph so that at 312, the query is run against the database 316.

In one embodiment, the system 100 may select top queries, filtered by minimum distance threshold at 320 (e.g., FIG. 2C). For example, depending on transaction volume for the account (e.g., the top queries may be a function or an inverse function of the number of transactions of the account over a given period), the system 100 may select the top 2 or three queries. At 322, the system 100 may determine whether there is any profile established for the account that is affected by the decline decision. If there is no profile, then the system 100 may terminate its process. If on the other than, there was a profile for the account, the system 100 may continue to 324 by estimating a chance of success using the latest inverse of the latest fraud model score (e.g., FIG. 2D). At 326, the system 100 may further determine an expected chance of pay off if the criminal 118 were to proceed with the proposal. At 328, the system 100 may determine whether the expected pay off exceeds threshold. If the determination is negative, the system 100 may terminate at 310. If the determination is positive, the system 100 may proceed to update the profiles for the account at 330. For example, the system 100 may have a separate database 332 storing profiles for various accounts. In one embodiment, the system 100 may routinely update the account history database 318 with real-time account profiles of past fraudsters or criminals 332 as a result of any actions done as a result of the transaction has been declined.

In one embodiment, the database may store fraudulent transactional data using a generated ID (which would be the fraudsters “account” as indicated above) instead of the actual account number. For example, the ID may link various fraudulent transactions together but may not be associated with a person or account. This generated ID may be created by using an unsupervised graph learner that clusters fraudulent transactions together. The resulting community, based on the score, would be the community ID. New fraudulent transactions would get the ID from the closest fraudulent transaction based on the transaction profile using a graph based similarity measure like Dijkstra's algorithm.

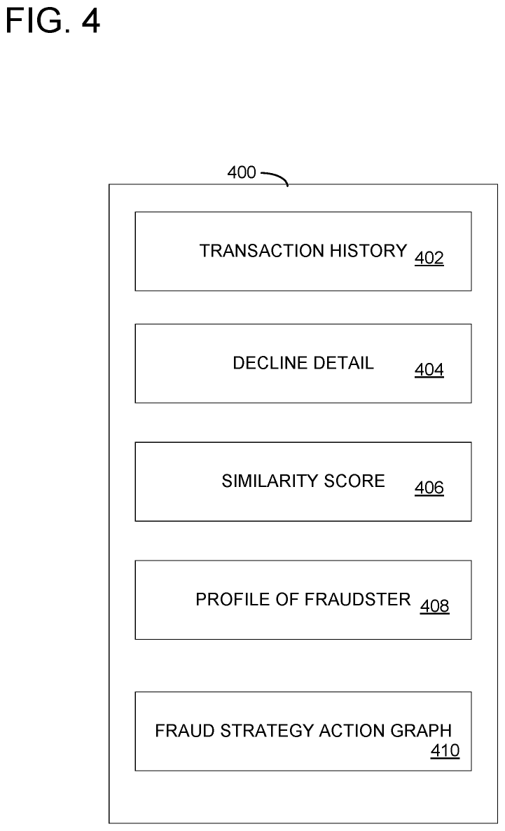

Referring now FIG. 4, a diagram illustrating a data structure for storing data according to one embodiment. For example, a data structure 400 may include a field 402 for storing transaction history of a fraudster or an account. A field 404 may store details of the decline. For example, the field 404 may store the number of previous declines, the decline TOD, amount, merchant, etc. A field 406 may store data related to a similarity score, as explained above. A field 408 may store data associated with a transaction, such as risk score, etc. The data structure 400 may also include a field 410 for storing data associated with fraud strategy action graphs.

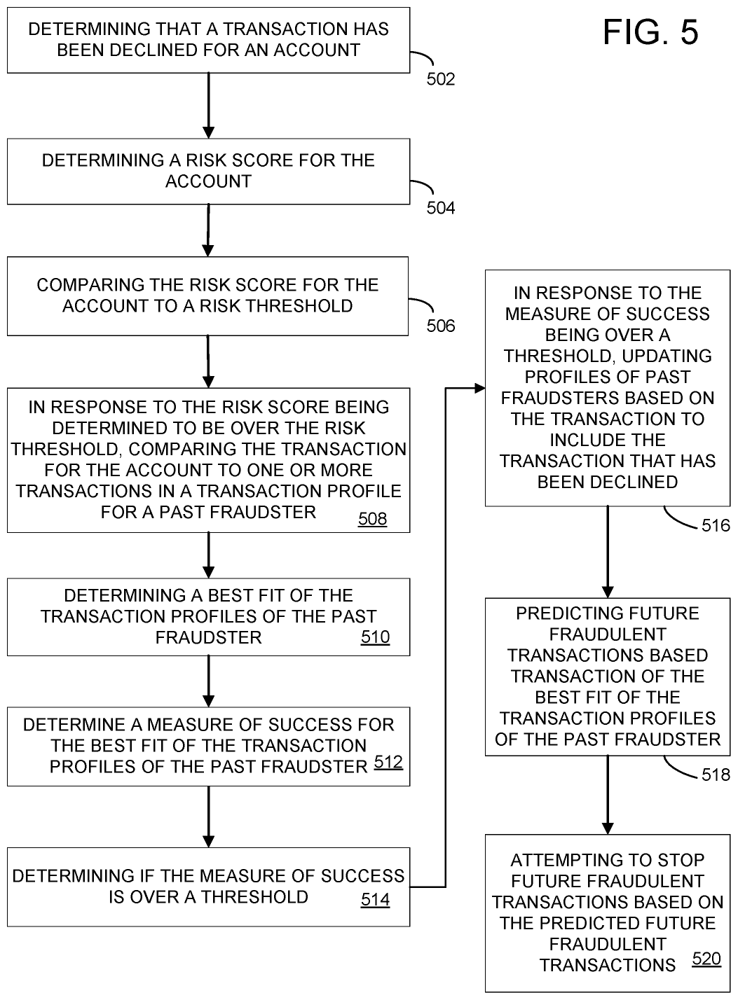

Referring now to FIG. 5, a flow diagram illustrating a method for embedding inferred reaction correspondence from decline data according to one embodiment. At 502, the system 100 may determine that a transaction has been declined for an account. At 504, it is further determined a risk score for the account. The system 100 may further compare the risk score for the account to a risk threshold at 506. In response to the risk score being determined to be over the risk threshold, the system 100 may compare the transaction for the account to one or more transactions in a transaction profile for a past fraudster at 508. The system 100 may further determine a best fit of the transaction profiles of the past fraudster at 510.

The system 100 may also determine a measure of success for the best fit of the transaction profiles of the past fraudster at 512. At 514, the system 100 may determine if the measure of success is over a threshold. At 516, in response to the measure of success being over a threshold, the system 100 may update profiles of past fraudsters based on the transaction to include the transaction that has been declined. The system 100 may further predict future fraudulent transactions of the best fit of the transaction profiles of the past fraudsters at 518. At 520, the system 100 may therefore attempt to stop future fraudulent transactions based on the predicted future fraudulent transactions.

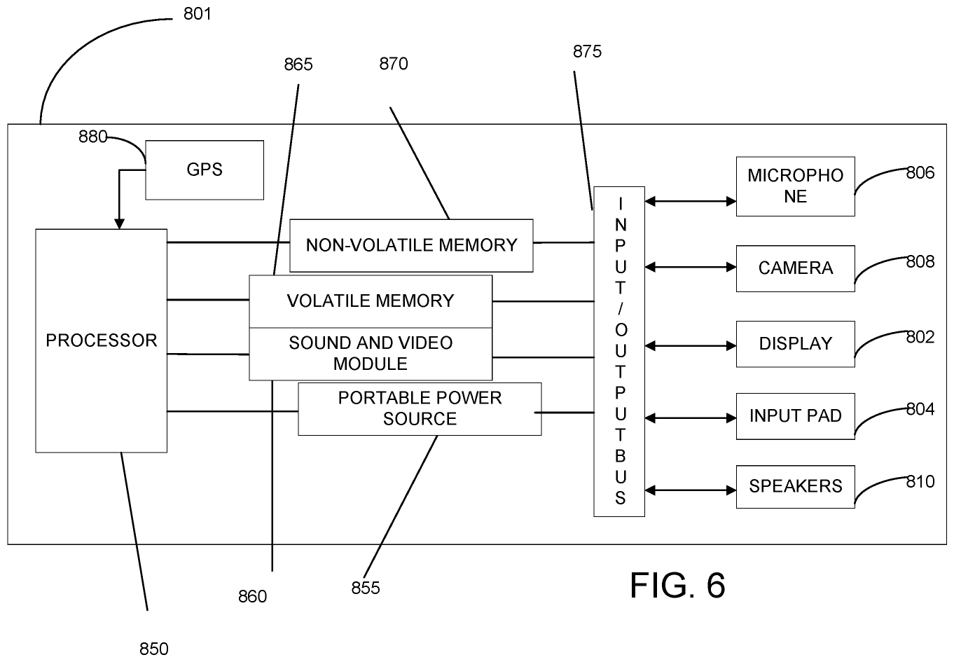

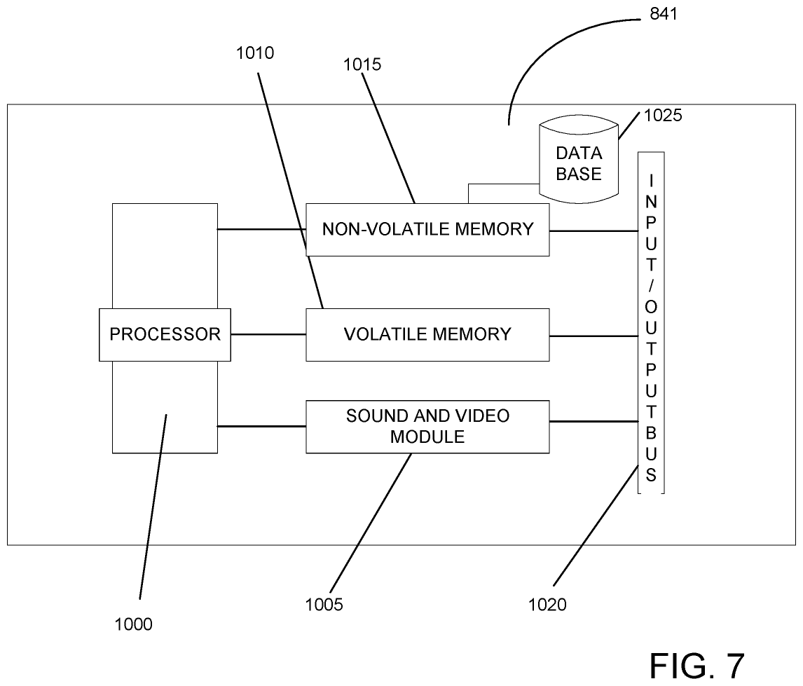

FIG. 6 may be a high level illustration of a portable computing device 801 communicating with a remote computing device 841 in FIG. 7 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 841. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc., FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have non-volatile memory 870 and volatile memory 865. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (e.g., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods for handling large amount of input data files where the data structure or schema is not provided. Rather, only a metadata description file of the input files is provided. Embodiments may then apply the description file to dynamically generate, at run-time, necessary reader or writer engines to process the data within the input files. Hardcoded files/scripts may no longer be needed to be preloaded to the system before processing the input files.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A computer-implemented method of using past transaction declines to predict future fraudulent behavior of an account comprising:
determining that a transaction has been declined for an account;
determining a risk score for the account;
comparing the risk score for the account to a risk threshold;
in response to the risk score being determined to be over the risk threshold, comparing the transaction for the account to one or more transactions in a transaction profile for a past fraudster;
determining a best fit of the transaction profiles of the past fraudster;
determining a measure of success for the best fit of the transaction profiles of the past fraudster;
determining if the measure of success is over a threshold;
in response to the measure of success being over a threshold, updating profiles of past fraudsters based on the transaction to include the transaction that has been declined;
predicting future fraudulent transactions; and
attempting to stop future fraudulent transactions based on the predicted future fraudulent transactions.

2. The computer-implemented method of claim 1, wherein the risk score is a determined value from analyzing past purchase history of the account holder using a risk score algorithm.

3. The computer-implemented method of claim 1, wherein a risk threshold is a level of risk determined to be acceptable for a purchase for an account holder.

4. The computer-implemented method of claim 1, wherein comparing the transaction for the account to one or more transactions in a transaction profile for a past fraudster uses a graph with the transaction and with the one or more transactions in a transaction profile for a past fraudster and the comparison is a distance on the graph of the transactions and the transactions of the fraudsters.

5. The computer-implemented method of claim 1, wherein the transaction profile comprises attempted transactions that proceeded and followed a fraudulent transaction for a purchaser.

6. The computer-implemented method of claim 1, wherein the finding the best fit comprises graphing the transaction and graphing the transactions from similar transaction profiles and finding the smallest total distance between the transaction and transactions of the past fraudster.

7. The computer-implemented method of claim 1, wherein finding the best fit comprises graphing the past transactions of the account and the past transaction from similar transaction profiled and finding the

8. The computer-implemented method of claim 1, wherein the measure of success comprises a dollar amount which the fraudster may expect.

9. The computer-implemented method of claim 1, wherein comparing the transaction for the account to one or more transactions for a past fraudster is made using a graph.

10. A system of using past transaction declines to predict future fraudulent behavior of an account comprising:
determining that a transaction has been declined for an account;
determining a risk score for the account;
comparing the risk score for the account to a risk threshold;
in response to the risk score being determined to be over the risk threshold, comparing the transaction for the account to one or more transactions in a transaction profile for a past fraudster;
determining a best fit of the transaction profiles of the past fraudster;
determining a measure of success for the best fit of the transaction profiles of the past fraudster;
determining if the measure of success is over a threshold;
in response to the measure of success being over a threshold, updating profiles of past fraudsters based on the transaction to include the transaction that has been declined;
predicting future fraudulent transactions; and
attempting to stop future fraudulent transactions based on the predicted future fraudulent transactions.

11. The system of claim 10, wherein the risk score is a determined value from analyzing past purchase history of the account holder using a risk score algorithm.

12. The system of claim 10, wherein a risk threshold is a level of risk determined to be acceptable for a purchase for an account holder.

13. The system of claim 10, wherein comparing the transaction for the account to one or more transactions in a transaction profile for a past fraudster uses a graph with the transaction and with the one or more transactions in a transaction profile for a past fraudster and the comparison is a distance on the graph of the transactions and the transactions of the fraudsters.

14. The system of claim 10, wherein the transaction profile comprises attempted transactions that proceeded and followed a fraudulent transaction for a purchaser.

15. The system of claim 10, wherein the finding the best fit comprises graphing the transaction and graphing the transactions from similar transaction profiles and finding the smallest total distance between the transaction and transactions of the past fraudster.

16. The system of claim 10, wherein finding the best fit comprises graphing the past transactions of the account and the past transaction from similar transaction profiled and finding the

17. The system of claim 10, wherein the measure of success comprises a dollar amount which the fraudster may expect.

18. The system of claim 10, wherein comparing the transaction for the account to one or more transactions for a past fraudster is made using a graph.

19. A computer-implemented method of using past transaction declines to predict future fraudulent behavior of an account comprising:
determining that a transaction has been declined for an account;
determining a risk score for the account;
comparing the risk score for the account to a risk threshold;
in response to the risk score being determined to be over the risk threshold, comparing the transaction for the account to one or more transactions in a transaction profile for a past fraudster;
determining a best fit of the transaction profiles of the past fraudster;
determining a measure of success for the best fit of the transaction profiles of the past fraudster;
determining if the measure of success is over a threshold;
in response to the measure of success being over a threshold,
updating profiles of past fraudsters based on the transaction to include the transaction that has been declined;
predicting future fraudulent transactions; and
attempting to stop future fraudulent transactions based on the predicted future fraudulent transactions.

20. The computer-implemented method of claim 1, wherein the risk score is a determined value from analyzing past purchase history of the account holder using a risk score algorithm.
